(19) United States
(12) Patent Application Publication
(10) Pub. No.: US 2019/0136829 A1
(43) Pub. Date: May 9, 2019

(54) System for Generating Electric Energy by Exploiting Wind at Height

(71) Applicant: Sequoia IT S.R.L., Moncalieri (IT)

(72) Inventor: Giovanni Vergnano, Moncalieri (IT)

(21) Appl. No.: 16/311,053

(22) PCT Filed: Jun. 20, 2017
(86) PCT No.: PCT/IT2017/000122

§ 371 Date: Dec. 18, 2018

(30) Foreign Application Priority Data
Jun. 28, 2016 (IT) 102016000067167

(51) Int. Cl. F03D 3/00; F03D 5/00; F03D 7/06

(52) U.S. Cl. CPC F03D 3/005; F03D 5/00; F05B 2220/706; F05B 2240/3121; F03D 7/06

(57) ABSTRACT

A system (1) is described for generating electric energy by exploiting wind at a height, comprising at least one ultra-light component of the kite type composed of two or more retractable wing profiles (11, 12) which can be extended or retracted through means placed inside a central housing (13), thereby obtaining both the chance of more easily rising and descending the kite, and the chance of regulating/controlling the working surface of the wing profiles (11, 12) depending on a wind intensity.

The present invention refers to a system for generating electric energy by exploiting wind at a height. Specifically, the invention deals with an implementation of the wind capitation technique with lightweight wing profiles “rotating” around their own axis (also rotor) and characterized by the chance of being “retractable”, namely “extended” or “compressed” in a central body/room. The rotation of the wing profiles, induced by wind, generates a force (lift) aligned to the rotation axis and whose direction is opposite to the constraint point of the system. Between the wind direction and the rotation axis an angle will be formed, induced by the cyclic modification of the wing profiles during the rotation, which keeps the system at a height. The transfer to the ground of energy produced by the system occurs through a constraining cable which, through a suitable pulley, connects the rotor, placed at a height, to a generator of electric energy or another similar system, placed on the ground. Recovery (descent) steps down to the starting height of the cycle must be alternated with traction steps, with the rotor rising at a height.

The term lightweight profiles means the aerodynamic shapes which deploy and keep or modify their own wing profile due to the help of tie-rods.

Some priror documents exist, WO2007000788, U.S. Pat. Nos. 4,832,571, 802,144, 704,507, but none of such documents uses the innovative feature of the present invention, which allows obtaining better performances when generating electric energy with rotating lightweight profiles.

Object of the present invention is solving the above prior art problems, by providing the following advantages and scopes:
facilitating the “recovery” step at the starting height of the working cycle of lightweight wing profiles, rotating on their own axis, which, due to traction, produce electric energy through a generator placed on the ground;
regulating/controlling, depending on wind intensity, the “working” surface for capturing wind energy (namely the surface exposed to wind) by the rotating wing profiles;
increasing the range of wind speeds which can be used to generate electric energy, since, in case of strong winds, it is possible to “reduce” the wing surface of the system and the parts which remain exposed to wind can be composed of stronger materials.

The above and other objects and advantages of the invention, as will result from the following description, are obtained with a system for generating electric energy by exploiting wind at a height as claimed in claim 1.

Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) can be made to what is described, without departing from the scope of the invention as appears from the enclosed claims.

The present invention will be better described by some preferred embodiments thereof, provided as a non-limiting example, with reference to the enclosed drawings, in which:

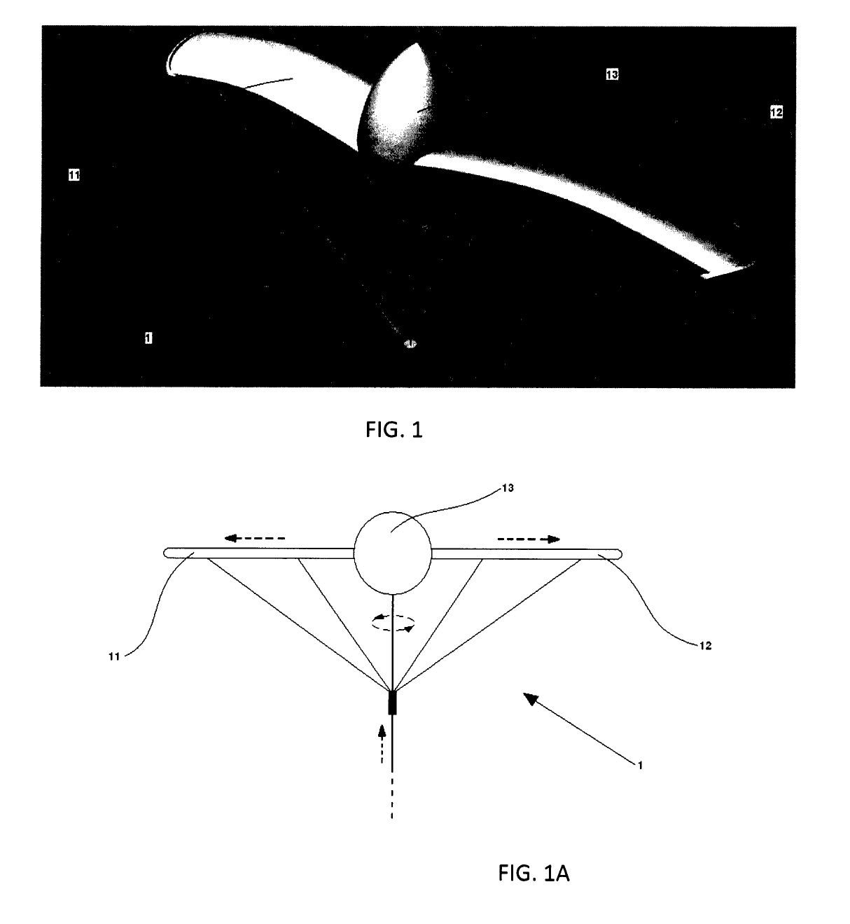

FIGS. 1, 1a show an example embodiment of the system according to the present invention, with “total” opening of the rotating wing profile;

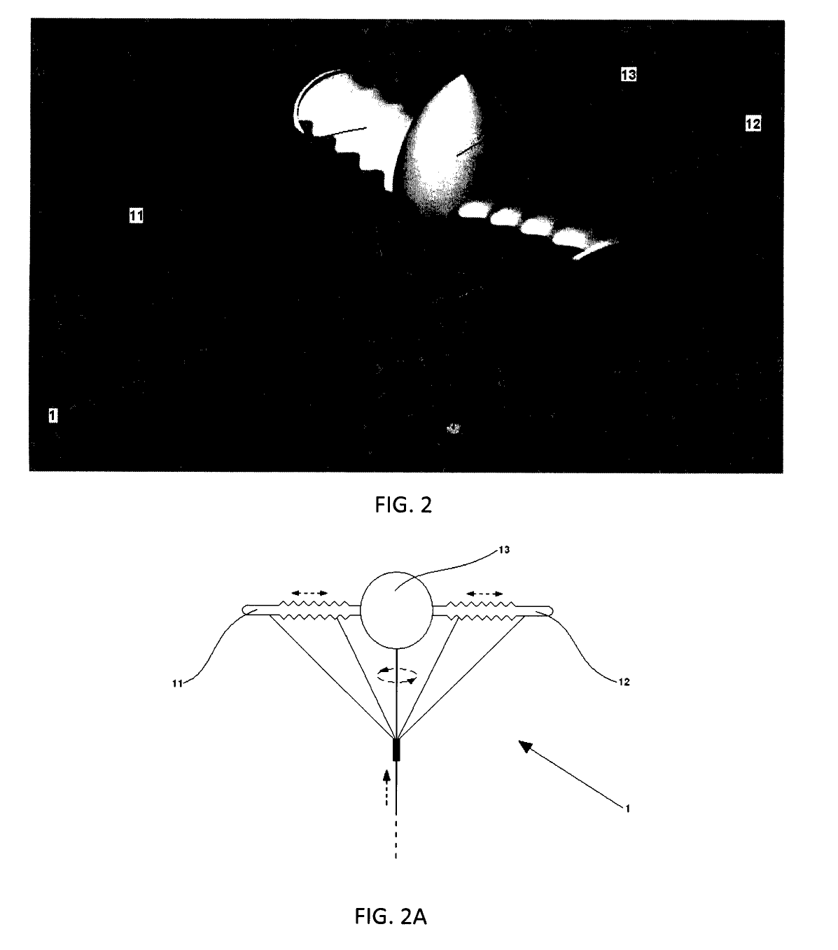

FIGS. 2, 2a show an example embodiment of the system according to the present invention, with “partial” opening of the rotating wing profile;

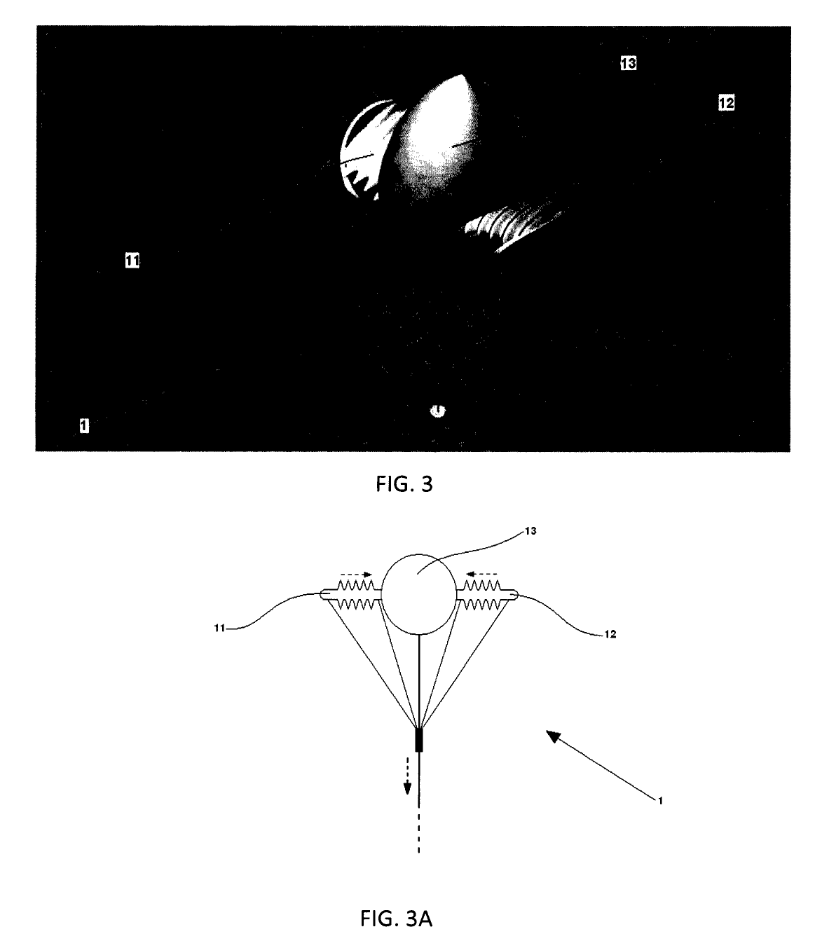

FIGS. 3, 3a show an example embodiments of the system according to the present invention, with “no” opening of the rotating wing profile;

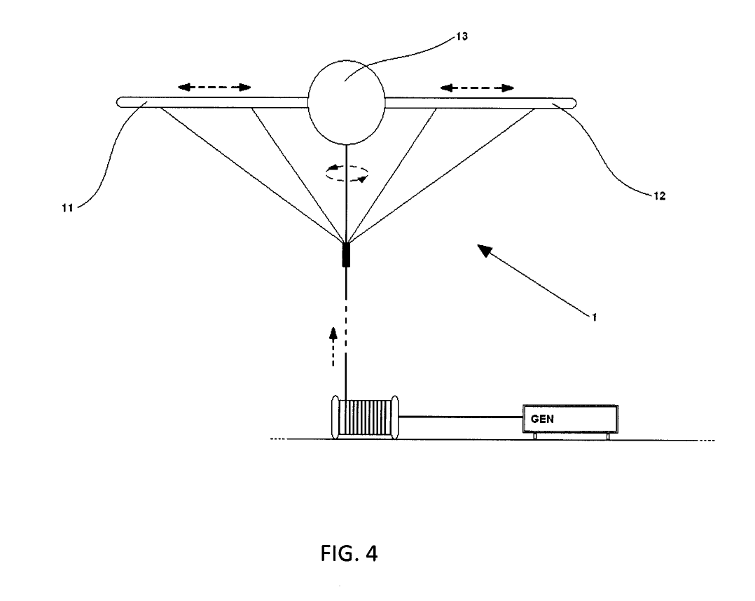

FIG. 4 shows a complete example embodiment of the system according to the present invention, with connection of the rotating wing profile to an electric energy generator placed on the ground.

With reference to the Figures, the invention deals with a system (1) for generating electric energy by exploiting wind at a height.

Specifically, the invention deals with an innovative system (1) equipped with special wing profiles “rotating” around their own axis and “retractable”, namely variably extendible, thereby obtaining the chance of changing the working surface for exploiting wind.

Such system (1) mainly comprises:
at least one ultra-light component of the “kite” type, such as to have an aerodynamic shape for which wind induces a rotation around its own axis creating a lift (for example like the blades of an helicopter); the “rotating kite” is mainly composed of two or more “retractable” wing profiles (11, 12) which can be extended or reduced (elongated or shortened), totally or partially, through means (mechanical and/or electromechanical) placed inside a central room/body (13) belonging to the rotating kite.

In this way, thanks of being able to extend or reduce (elongate or shorten) the wing profiles (11, 12), a functional improvement can be obtained in the rise and descent steps (where there is no risk of worsening for the cables which control the shape of the wing profiles), and it will also be possible to regulate/control the working surface (namely the wing surface which can be exploited by wind) of the wing profiles (11, 12), depending on wind intensity, thereby improving the performances of the system (1).

When there is wind, the wing profiles (11, 12) are “totally” opened (FIGS. 1, 1a), namely are completely extended, elongated, and the system (1) can also exploit/use the wind energy of weaker winds, which can be searched also at high altitudes.

When the profiles (11, 12) are “partially” opened (FIGS. 2, 2a), namely are only partially extended, elongated, the rotating kite can exploit very strong winds, without risks for material resistance.

When the profiles (11, 12) are “closed” (FIG. 3, 3a) inside the central room (13) of the system (1), namely are totally recovered, collected, in the central body/room (13), the kite will go down till the “cycle start” height or down to the ground level, if required.

The wing profiles (11, 12) of the system (1) go out and go in, totally or partially, of anf to the central room (13).

The central room (13) of the system (1) is preferably of a spherical or oval shape.

The central room/body (13) can be also composed of an aerostatic balloon adapted to keep the system at a height even when there is no wind.

When there is wind, the whole system, including the central room (13) and the constraining cables of the wing profiles, rotates around its own axis, while the ground constraining cable is connected with a rotary joint, so that there is no torsional effect of the cable during the rotation.

The rotation produces on the wing profiles (11, 12) a wind, which in aerodynamics is defined as “apparent”, which determines the same lift effects which are obtained with a driven kite or with a system of rotary blades like those of an helicopter. The lift generated by the rotation, which has a force whose direction is opposite to the constraining point, is transmitted by the constraining cable to the system for converting mechanical energy (produced by the rotation due to wind) into electric energy, which is placed on the ground.

The system (1) can generate electric energy because the constraining cable is connected to an electric generator placed on the ground. Obviously, there can be other uses, such as, for example, the actuation of hydraulic pumps to remove salt or the lifting of liquid masses.

Electric energy is generated because the central room (13) of the rotating kite at a height is connected, through a cable wound onto pulleys, to a generator/alternator placed at ground level (FIG. 4).

When there is no wind, there is no rotation of the rotating kite around its own axis and therefore there is no production of electric energy by the system (1).

The energy generating cycle, which is obtained during the “rise” at a height of the wing profiles (11,12), must be followed by a step of “returning” to the initial height with low energy consumptions.

1-6. (canceled)

7. Apparatus for generating energy by exploiting wind at a height from a ground surface, comprising:
an ultralight kite component comprising:
a central housing;
wing profiles each having a working surface, the wing profiles configured to extend away from the central housing and retract toward the central housing and configured to rotate the kite component and to raise the kite component when there is sufficient wind, either strong or weak;
means within the central housing for controlling the working surfaces of the wing profiles such that—
when there is weak wind the wing profiles fully extend, placing the kite component in a working cycle,
when there is strong wind the wing profiles partially extend, placing the kite component in a working cycle, and
when there is insufficient wind, the wing profiles close, such that the kite drops until either there is moderate wind or a high amount of wind again, or the kite component reaches the ground surface; and
means for transferring energy from spinning of the kite component to the ground.

8. The apparatus of claim 7 wherein the wing profiles are further configured to retract within the central housing.

9. The apparatus of claim 7 wherein the kite component is further configured to rotate around the axis of the central housing and the wing profiles and to generate apparent wind and consequent lift on the wing profiles.

10. The apparatus of claim 7 wherein the means for transferring energy comprises an electrical generator and a cable attached between the central housing and the electrical generator, and wherein the cable is attached to the electrical generator in a manner to prevent substantial torsion on the cable.

11. The apparatus of claim 10 wherein the central housing has either a spherical or oval shape.

12. The apparatus of claim 10 wherein the central housing further comprises an aerostatic balloon capable of keeping the kite component at a height when there is insufficient wind.

13. The apparatus of claim 7 wherein the central housing has either a spherical or oval shape.

14. The apparatus of claim 7 wherein the central housing further comprises an aerostatic balloon capable of keeping the kite component at a height when there is insufficient wind.
